(19) United States
(12) Patent Application Publication
(10) Pub. No.: US 2010/0149123 A1
(43) Pub. Date: Jun. 17, 2010

(54) DIGITAL PHOTOGRAPHING APPARATUS INCLUDING A TOUCHSCREEN COMPOSITION INPUT

(75) Inventors: Jae-joon Choi, Suwon-si (KR); Min-su Kang, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/635,962

(22) Filed: Dec. 11, 2009

(30) Foreign Application Priority Data
Dec. 17, 2008 (KR) 10-2008-0128648

(51) Int. Cl. G06F 3/041; H04N 5/222

(52) U.S. Cl. 345/173; 348/333.01; 348/E05.022

(57) ABSTRACT

A method of controlling a digital photographing apparatus includes providing a touchscreen input view on a touchscreen and inputting a touchscreen composition input drawn by a user on the touchscreen. The touchscreen composition input may represent a picture of a desired composition. When the touchscreen composition input is completely drawn, the touchscreen composition input may be displayed in a live view along with a live view input. The touchscreen composition input may be displayed in such a manner that the touchscreen composition input overlaps with the live view input in the live view.

### CROSS-REFERENCE TO RELATED PATENT APPLICATION

This application claims the priority benefit of Korean Patent Application No. 10-2008-0128648, filed on Dec. 17, 2008, in the Korean Intellectual Property Office, the disclosure of which is incorporated herein in its entirety by reference.

### BACKGROUND

1. Field of the Invention

The present invention relates to a digital photographing apparatus including a touchscreen, a method of controlling the digital photographing apparatus, and a computer-readable storage medium storing a computer program for executing the method.

2. Description of the Related Art

As touchscreens have been widely distributed, digital photographing apparatuses including touchscreens have been marketed. A touchscreen refers to a display screen that acts as an input device by responding to the touch of a user. When the user touches the touchscreen with his/her finger or passive objects, such as a stylus, the touchscreen senses the location of the touch. Since the touchscreen performs both a display function and an input device function, an electronic device employing the touchscreen can be reduced in size. Also, since the user can directly touch a desired point while watching the touchscreen, even one who does not know how to effectively handle the electronic device can easily use the electronic device.

Compact digital cameras are designed to be portable. However, pictures mostly do not include the user who takes the pictures. If the user wants to be photographed, the user will have to ask someone to photograph the user.

### SUMMARY

An embodiment of a digital photographing apparatus according to an aspect of the present invention may more easily show a desired composition in a live view by using a touchscreen.

According to an aspect of the present invention, a method of controlling a digital photographing apparatus comprises providing a touchscreen input view on a touchscreen, and detecting a touchscreen composition input drawn by a user on the touchscreen. The touchscreen composition input may represent a picture of a desired composition. The method may also comprise displaying the touchscreen composition input in a live view along with a live view input, when the touchscreen composition input is completely drawn. The displaying of the touchscreen composition input may comprise overlapping the touchscreen composition input with the live view input in the live view.

The method may further comprise removing the touchscreen composition input from the live view in response to the user's input requesting to remove the touchscreen composition input. When photographing is completed, the method may further comprise removing the touchscreen composition input from the live view.

The touchscreen input view may include a view displaying a previously stored image file.

According to another aspect of the present invention, a digital photographing apparatus comprises a touchscreen and a composition input control unit. The composition input control unit may have a touchscreen input coupled with the touchscreen to receive a touchscreen composition input from the touchscreen. The touchscreen composition input may represent a picture of a desired composition drawn by a user on the touchscreen. The composition input control unit may also have a touchscreen output coupled with the touchscreen to provide a touchscreen input view on the touchscreen, and when the touchscreen composition input is completely drawn in the touchscreen input view, to display the touchscreen composition input along with a live view input on the touchscreen in a live view. The composition input control unit may display the touchscreen composition input in such a manner that the touchscreen composition input overlaps with the live view input in the live view.

The composition input control unit may remove the touchscreen composition input from the live view in response to the user's input requesting to remove the touchscreen composition input. When photographing is completed, the composition input control unit may remove the touchscreen composition input from the live view.

The touchscreen input view may include a view displaying a previously stored image file.

According to another aspect of the present invention, a computer-readable storage medium may have stored thereon a computer program executable by a processor, the computer program comprising a code programmed to provide a touchscreen input view on a touchscreen, and a code programmed to detect touchscreen composition input drawn by a user on the touchscreen. The touchscreen composition input may represent a picture of a desired composition. The computer program may further comprise a code programmed to display the touchscreen composition input in a live view along with a live view input, when the touchscreen composition input is completely drawn. The computer program may further comprise a code programmed to display the touchscreen composition input and may comprise a code programmed to overlap the touchscreen composition input with the live view input in the live view.

The computer program may further comprise a code programmed to remove the touchscreen composition input from the live view in response to the user's input requesting to remove the touchscreen composition input. The computer program may further comprise a code programmed to remove the touchscreen composition input from the live view when photographing is completed.

The touchscreen input view may include a view displaying a previously stored image file.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a digital photographing apparatus according to an embodiment of the present invention;

FIG. 2 is a flowchart illustrating a method of controlling the digital photographing apparatus of FIG. 1, according to an embodiment of the present invention;

FIG. 3 illustrates views according to the present invention; and

FIG. 4 is a block diagram of a digital photographing apparatus according to another embodiment of the present invention.

### DETAILED DESCRIPTION

The present invention will now be described more fully with reference to the accompanying drawings, in which exemplary embodiments of the invention are shown. The following description and the attached drawings are provided for better understanding of the invention, and description of techniques or structures related to the present invention which would have been obvious to one of ordinary skill in the art may be omitted.

The preferred embodiments should be considered in a descriptive sense only and not for purposes of limitation. Therefore, the scope of the invention is defined not by the detailed description of the invention but by the appended claims. The terms and words which are used in the present specification and the appended claims should not be construed as being confined to common meanings or dictionary meanings but be construed as meanings and concepts matching with the technical spirit of the present invention in order to describe the present invention in the best fashion.

The present invention will now be described more fully with reference to the accompanying drawings, in which the exemplary embodiments of the invention are shown.

The present invention relates to a digital photographing apparatus, which allows a user to directly draw a picture of a desired composition, which is a touchscreen input, on a touchscreen display and displaying the touchscreen input in a live view in such a manner that the touchscreen input overlaps with a live view input, a method of controlling the digital photographing apparatus, and a computer-readable storage medium. If a user of a conventional digital photographing apparatus needs to ask someone to photograph the user and conceives a desired composition, the user may verbally explain to the someone about the desired composition. However, if a user of the digital photographing apparatus according to the present invention needs to ask someone to photograph the user, the digital photographing apparatus can display a picture of a desired composition which the user inputs using a touchscreen in such a manner that the desired composition input using the touchscreen overlaps with a live view input and the someone can effectively photograph in the desired composition. Also, since the digital photographing apparatus allows the user to directly draw the picture of the desired composition on the touchscreen display, any user including one who does not get used to handling the digital photographing apparatus can easily set the desired composition. Since the touchscreen input can be more easily accessed by the user than a user input interface using operation keys, the digital photographing apparatus according to the present invention may use the touchscreen as means for inputting a composition.

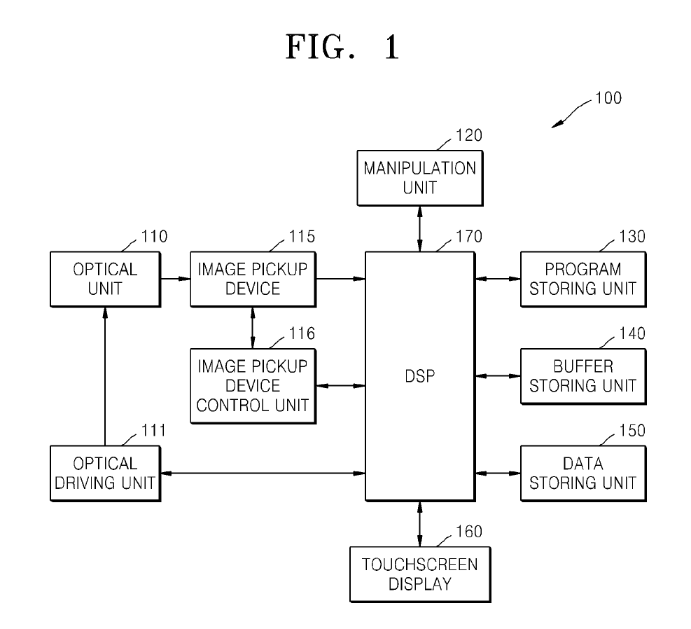

FIG. 1 is a block diagram of a digital photographing apparatus 100 according to an embodiment of the present invention.

Referring to FIG. 1, the digital photographing apparatus 100 may include an optical unit 110, an optical driving unit 111, an image pickup device 115, an image pickup device control unit 116, a manipulation unit 120, a program storing unit 130, a buffer storing unit 140, a data storing unit 150, a touchscreen display 160, and digital signal processing (DSP) unit 170.

The optical unit 110 provides an optical signal input from a subject to the image pickup device 115. The optical unit 110 may include at least one of a zoom lens varying the angle of view according to a focal length and a focus lens focusing the subject. The optical unit 110 may further include an aperture adjusting the amount of light.

The optical driving unit 111 determines the position of a lens and whether the aperture is opened or closed. The optical driving unit 111 may focus by moving the lens, and may adjust the amount of light by determining whether the aperture is opened or closed. The optical driving unit 111 may control the optical unit 110 according to a control signal that is automatically generated from an image signal that is input in real time, or according to a control signal that is manually input by a user.

The optical signal transmitted through the optical unit 110 forms an image of the subject on a light receiving surface of the image pickup device 115. The image pickup device 115 may include a charge coupled device (CCD) or a complementary metal oxide semiconductor image sensor (CIS) which converts the optical signal into an electrical signal. The sensitivity of the image pickup device 115 may be controlled by the image pickup device control unit 116. The image pickup device control unit 116 may control the image pickup device 115 according to a control signal that is automatically generated from an image signal that is input in real time, or according to a control signal that is manually input by the user.

The manipulation unit 120 may input an external control signal, for example, a control signal entered by the user. The manipulation unit 120 includes buttons having various functions, such as a shutter-release button pressed to input a shutter-release signal and expose the image pickup device 115 to light for a predetermined period of time, a power button pressed to supply power, a wide angle-zoom button and a telephoto-zoom button pressed to widen or narrow the angle of view according to an input, a mode button pressed to select a text input mode, a photo mode, or a play mode, a white balance button, and an exposure lock button. However, the manipulation unit 120 is not limited thereto, and may be any type, e.g., a keyboard, a touchpad, a touchscreen, or a remote controller, as long as the manipulation unit 120 is used as an input device.

The digital photographing apparatus 100 further includes an operating system driving the digital photographing apparatus 100, the program storing unit 130 storing a program, such as an application system, the buffer storing unit 140 temporarily storing data necessary for computing or data resulting from the computing, and the data storing unit 150 storing various pieces of information necessary for the program including an image file containing an image signal.

The digital photographing apparatus 100 includes the touchscreen display 160 displaying the operating state of the digital photographing apparatus 100, or information about an image photographed by the digital photographing apparatus 100. The touchscreen display 160 may provide visual information and/or auditory information to the user. The touchscreen display 160 may input data through the user's touch. Accordingly, the touchscreen display 160 and the manipulation unit 120 collectively operate as a user input interface.

The digital photographing apparatus 100 includes the DSP unit 170 processing an input image signal and controlling each element according to the input image signal or an external input signal.

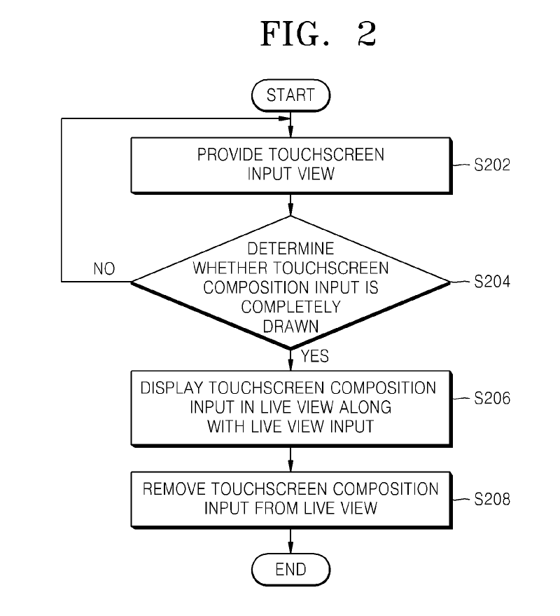

FIG. 2 is a flowchart illustrating a method of controlling the digital photographing apparatus 100 of FIG. 1, according to an embodiment of the present invention.

The method may start in response to an action where the user enters a composition setting mode or the user draws a picture on the touchscreen display 160.

In operation S202, a touchscreen input view is provided on the touchscreen display 160. The user may schematically draw a picture of a desired composition on the touchscreen display 160 with his/her finger or by using passive objects such as a stylus. A touchscreen input, which is the picture of the desired composition directly drawn by the user, is referred to as a touchscreen composition input.

When the touchscreen input view is provided, an image file, which is previously stored in the digital photographing apparatus 100, may be displayed, and in this case, the user may draw the picture of the desired composition with reference to the image file. The image file displayed when the touchscreen input view is provided may be optional. Alternatively, when the touchscreen input view is provided, a live view input may be displayed.

In operation S204, it is determined whether the touchscreen composition input is completely drawn. Whether the touchscreen composition input is completely drawn may be determined by the user's input indicating that the touchscreen composition input is completely drawn. Alternatively, if there is no touchscreen input for a predetermined period of time, it may be determined that the touchscreen composition input is completely drawn.

In operation S206, the touchscreen composition input is displayed in the live view along with the live view input. The live view input refers to an image input by the image pickup device 115 of the digital photographing apparatus 100, and the live view refers to a view seamlessly displaying the live view input in real time.

In operation S208, the touchscreen composition input is removed from the live view. The touchscreen composition input may be removed in response to the user's input requesting to remove the touchscreen composition input. Alternatively, the touchscreen composition input may be removed from the live view when one photographing operation is completed while the touchscreen composition input is displayed or when a predetermined period of time passes.

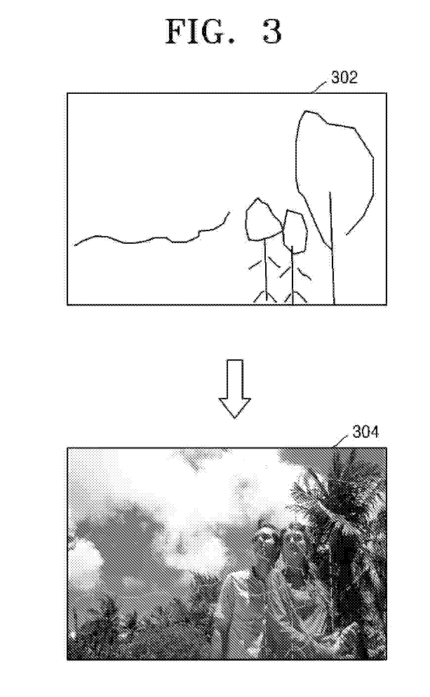

FIG. 3 illustrates views 302 and 304 according to the present invention.

The view 302 shows that a user directly draws a picture of a desired composition on the touchscreen display 160. The view 304 shows that, if it is determined that a touchscreen composition input is completely drawn, the touchscreen composition input is displayed in such a manner that the touchscreen composition input overlaps with a live view input.

In order to see both the touchscreen composition input and the live view input, the touchscreen composition input may be displayed semitransparently or with a dashed line. The touchscreen composition input is generally displayed with a line representing edges, but the present invention is not limited thereto.

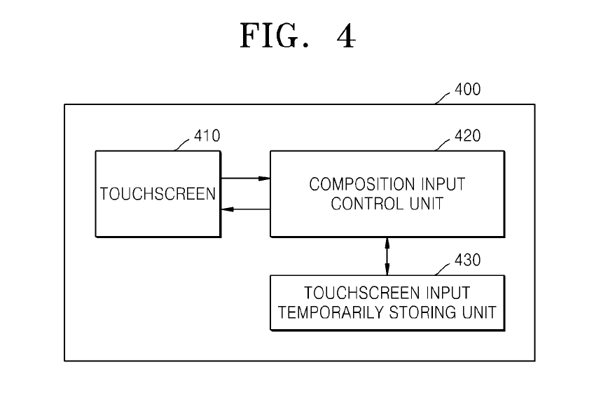

FIG. 4 is a block diagram of a digital photographing apparatus 400 according to another embodiment of the present invention.

Referring to FIG. 4, the digital photographing apparatus 400 may include a touchscreen 410, a composition input control unit 420, and a touchscreen input temporarily storing unit 430.

The touchscreen 410 is configured so that a user can draw a picture of a desired composition which is referred to as a touchscreen composition input. The touchscreen 410, which includes a display device, may display a live view input, a stored image file, etc. The touchscreen 410 of FIG. 4 may correspond to the touchscreen display 160 of the digital photographing apparatus 100 of FIG. 1, and may be any type as long as the user can draw a picture on the touchscreen 410.

The composition input control unit 420 stores the touchscreen composition input by the touchscreen 410 in the touchscreen input temporarily storing unit 430, and displays the touchscreen composition input in a live view in such a manner that the touchscreen composition input overlaps with the live view input. The composition input control unit 420 removes the touchscreen composition input from the live view in response to the user's input or under predetermined conditions. The composition input control unit 420 of FIG. 4 may correspond to the program storing unit 130 of FIG. 1, which stores a computer program to perform such operations as operations of the composition input control unit 420, and the DSP unit 170 of FIG. 1, which executes the computer program stored in the program storing unit 130. Alternatively, the composition input control unit 420 may be configured using hardware.

The touchscreen input temporarily storing unit 430 temporarily stores the touchscreen composition input. The touchscreen input temporarily storing unit 430 of FIG. 4 may correspond to the buffer storing unit 140 of FIG. 1. The touchscreen input temporarily storing unit 430 may be any type as long as the touchscreen input temporarily storing unit 430 can be mounted on the digital photographing device 400.

As described above, according to a digital photographing apparatus according to the present invention, a touchscreen input, which is a picture of a desired composition, can be displayed along with a live view input by drawing the picture of the desired composition on a touchscreen by a user. Accordingly, even someone who does not know how to effectively handle the digital photographing apparatus can easily display the touchscreen input along with the live view input.

The present invention may be embodied as computer-readable codes on a computer-readable recording medium. The computer-readable recording medium is any data storage device that can store data which can be thereafter read by a computer system.

The computer-readable codes are configured to perform the operations of the method according to the present invention when being read and executed from the computer-readable storage medium, for example by the DSP unit 170. The computer-readable codes may be realized with various programming languages. Functional programs, codes, and code segments for embodying the present invention may be easily derived by programmers in the art to which the present invention belongs.

Examples of the computer-readable recording medium include read-only memories (ROMs), random-access memories (RAMs), CD-ROMs, magnetic tapes, floppy disks, and optical data storage devices. The computer-readable recording medium may be a carrier wave that transmits data via the Internet, for example. The computer readable medium may be distributed among computer systems that are interconnected through a network, and the present invention may be stored and implemented as computer readable codes in the distributed system.

While the present invention has been particularly shown and described with reference to exemplary embodiments thereof using specific terms, the embodiments and terms have been used to explain the present invention and should not be construed as limiting the scope of the present invention defined by the claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling a digital photographing apparatus, the method comprising:
providing a touchscreen input view on a touchscreen;
detecting a touchscreen composition input drawn by a user on the touchscreen, the touchscreen composition input representing a picture of a desired composition; and
displaying the touchscreen composition input in a live view along with a live view input, when the touchscreen composition input is completely drawn.

2. The method of claim 1, wherein displaying the touchscreen composition input comprises overlapping the touchscreen composition input with the live view input in the live view.

3. The method of claim 1, further comprising removing the touchscreen composition input from the live view in response to the user's input requesting to remove the touchscreen composition input.

4. The method of claim 1, further comprising removing the touchscreen composition input from the live view when photographing is completed.

5. The method of claim 1, wherein the touchscreen input view includes a view displaying a previously stored image file.

6. A digital photographing apparatus comprising:
a touchscreen; and
a composition input control unit having
a touchscreen input coupled with the touchscreen to receive a touchscreen composition input from the touchscreen, the touchscreen composition input representing a picture of a desired composition drawn by a user on the touchscreen, and
a touchscreen output coupled with the touchscreen to provide a touchscreen input view on the touchscreen, and when the touchscreen composition input is completely drawn in the touchscreen input view, to display the touchscreen composition input along with a live view input on the touchscreen in a live view.

7. The digital photographing apparatus of claim 6, wherein when the composition input control unit displays the touchscreen composition input along with the live view input on the touchscreen, the touchscreen composition input overlaps with the live view input.

8. The digital photographing apparatus of claim 6, wherein the composition input control unit removes the touchscreen composition input from the live view in response to the user's input requesting to remove the touchscreen composition input.

9. The digital photographing apparatus of claim 6, wherein, when photographing is completed, the composition input control unit removes the touchscreen composition input from the live view.

10. The digital photographing apparatus of claim 6, wherein the touchscreen input view includes a view displaying a previously stored image file.

11. A computer-readable storage medium having stored thereon a computer program executable by a processor, the computer program comprising:
a code programmed to provide a touchscreen input view on a touchscreen;
a code programmed to detect a touchscreen composition input drawn by a user on the touchscreen, the touchscreen composition input representing a picture of a desired composition; and
a code programmed to display the touchscreen composition input in a live view along with a live view input, when the touchscreen composition input is completely drawn.

12. The computer-readable storage medium of claim 11, wherein the code programmed to display the touchscreen composition input comprises a code programmed to overlap the touchscreen composition input with the live view input in the live view.

13. The computer-readable storage medium of claim 11, wherein the computer program further comprises a code programmed to remove the touchscreen composition input from the live view in response to the user's input requesting to remove the touchscreen composition input.

14. The computer-readable storage medium of claim 11, wherein the computer program further comprises a code programmed to remove the touchscreen composition input from the live view when photographing is completed.

15. The computer-readable storage medium of claim 11, wherein the touchscreen input view includes a view displaying a previously stored image file.
